(19) United States
(12) Patent Application Publication
(10) Pub. No.: US 2011/0200220 A1
(43) Pub. Date: Aug. 18, 2011

(54) SOUND RECORDABLE/PLAYABLE DEVICE, PACKAGING, AND METHOD OF USE

(75) Inventor: Sheila A. Wright, Bloomfield Hills, MI (US)

(73) Assignee: ANN WILLIAMS GROUP, LLC., Bloomfield Hills, MI (US)

(21) Appl. No.: 13/022,722

(22) Filed: Feb. 8, 2011

Related U.S. Application Data
(60) Provisional application No. 61/303,812, filed on Feb. 12, 2010.

(51) Int. Cl. H04R 1/02

(52) U.S. Cl. 381/332

(57) ABSTRACT

A portable and wearable sound recordable and playable device comprising:
a front cover and a back cover, that form a housing, which includes a cavity for holding componentry; the componentry including at least a microphone and a speaker,
wherein the front cover and back cover are substantially similar in shape and include a curvature so that a cavity of air is formed between the speaker and the front wall cover;
wherein the front cover and the back cover when attached form an acoustic geometry.

### CLAIM OF BENEFIT OF FILING DATE

The present application claims the benefit of the filing date of U.S. Provisional Application No. 61/303,812, filed Feb. 12, 2010, the contents of which are hereby expressly incorporated by reference.

### TECHNICAL FIELD

The present invention pertains generally to portable and wearable digital audio recordable and playable devices, and more particularly to digital audio recordable and playable wristbands or pendants.

### BACKGROUND OF INVENTION

Existing wearable devices with record and playback features are generally limited to watches that include an additional recordable/playable feature. The existing audio recordable/playable watches suffer a disadvantage in that they are bulky and have poor sound quality due to focusing the design and packaging primarily on timekeeping, music playing, or other functions apart from recording and playback. Further, due to the need for a display window, packaging requirements tend to limit the range of geometric configuration options, and will tend to result in devices that are not aesthetically pleasing, or that prohibit or otherwise limit customization.

Some wearable devices exist that require the device to be connected to a computer to playback the recording. This has the potential to limit the useful application of the devices as they tend to be expensive, complex, and often require a part for attachment to the computer.

Various portable devices exist with recording capability, playback capability, or both. However, these tend to be packaged along with other electronic components (e.g., a music player such as an MP3 player), which cause the devices to be more expensive, require special manufacturing, special packaging considerations, or a combination thereof. Also because there are multiple electronic components packaged together the space is limited and the components must be reduced in size (increasing cost or reducing quality or both). With some of the existing applications the speaker and microphone have been reduced in size to the point that the user must yell into the microphone to even record a message; the user must press the speaker against their ear to hear the message, or both. Further, various such devices are part of some other article (e.g., a key ring, a writing instrument, or otherwise). which may limit the convenience with which the devices can be used, or which could easily become lost, such as when used by children.

Another problem with existing devices is that many of the devices are not compact. If larger parts are used it only increases the size of the housing. Once a larger housing is employed the recordable/playable device cannot be comfortably worn by women or children because the rigid componentry generally will not flex to conform comfortably to a smaller wrist.

Examples of efforts to address portable recordable devices are illustrated in U.S. Pat. Nos. 4,791,741, 5,387,108, 5,444,673, 5,999,494, D320,793, and D317,162, and U.S. Patent Application Publication 2009/0074224, all incorporated by reference. Heretofore, the art has complicated the approach to recordable wearable wrist devices by trying to package many features in an attractive and useful device. The result has been a widespread general lack of consumer acceptance of such devices.

Accordingly, it would be attractive to have a portable and wearable digital audio recordable and playable device that overcomes one or more of the above disadvantages.

### SUMMARY OF THE INVENTION

The present invention meets this need by providing a solution in the form of a portable and wearable sound recordable device that includes a front cover and a back cover, forming a housing, the housing including a cavity for holding componentry; the componentry including at least a microphone and a speaker; the front cover and back cover are substantially similar in shape and include a curvature so that a cavity of air is formed between the speaker and the front wall cover; and the front cover and the back cover when connected form an acoustic geometry. Also an air gap formed between speaker peripheral portion and opposing circuit boards.

The present invention may also include a microphone that is oriented perpendicular to a battery; the microphone may face a side of the front cover, back cover, or both. The speaker may be mounted on a housing that is attached to the front cover. For example, the speaker may be snap fit (e.g. via an interference fit with a flange, beneath a projecting tongue) and/or glued onto the housing. The device may include a lock switch to prevent accidental erasure of messages. Such lock switch may be shaped in a manner so that it substantially conforms to the shape of the cover. The front cover, the back cover, or both may include one or more fittings so that the front cover and the back cover can be snap fit together and will resist separation after being dropped onto a hard surface (e.g. a hard flooring such as concrete, wood, ceramic. or the like) from a height of at least 1.2 m. The fittings may include one or more cantilever projections that are sized to secure an opposing structure in an interfering relationship. The fittings may include one or more annular snaps. The housing may free of exposed mechanical fasteners, such as screws.

### DESCRIPTION OF DRAWINGS

### Brief Description of the Drawing

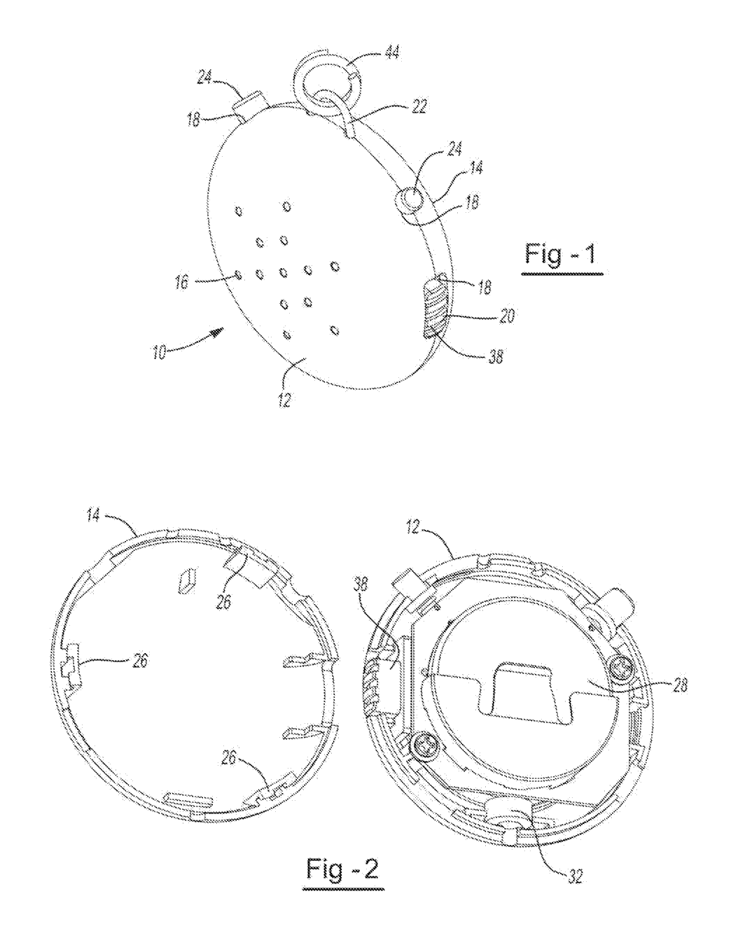

FIG. 1 is a perspective view of an illustrative device of the invention;

FIG. 2 is an elevational view of inside of the device;

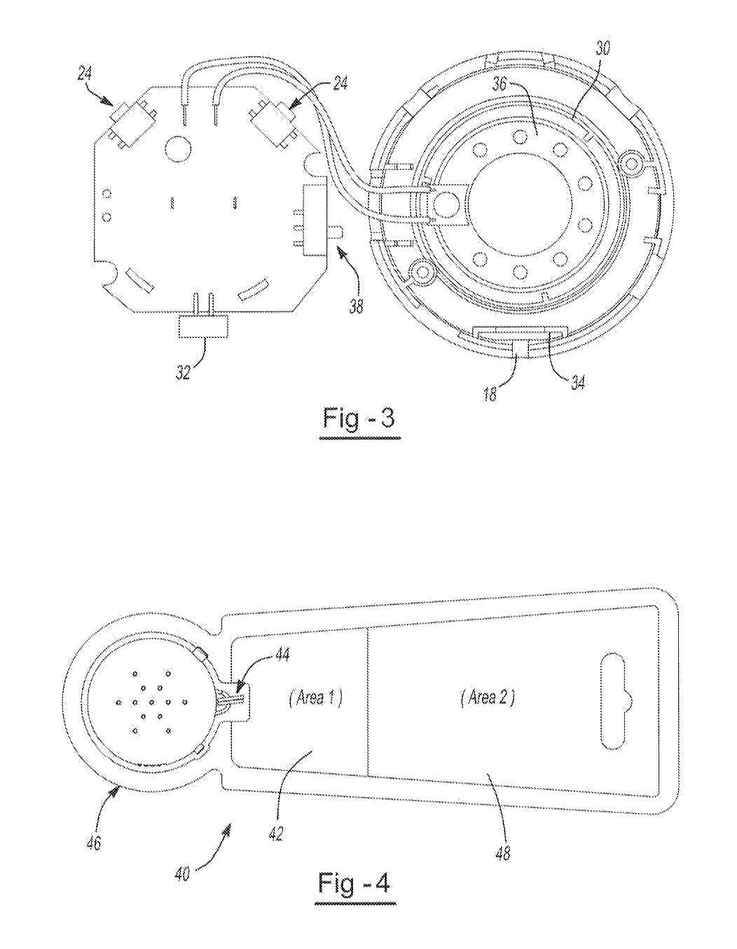

FIG. 3 is an elevational view of exposed componentry of the invention; and

FIG. 4 is an elevational view of a possible packaging configuration.

### DETAILED DESCRIPTION

Though the invention is not limited to the embodiments of the drawings; the structures shown in the drawings are contemplated as within the scope of the teachings, as wells as the relative proportions shown therein, which in turn may vary by about 10, 20%, or more. Elements shown in the drawings, even if not verbally described should be considered as within the teachings herein, as well. Further, the circuits shown herein are also contemplated as within the scope of the teachings.

Turning now to the detailed illustrations of examples of the invention and with reference to the drawings. FIG. 1 shows one possible embodiment of the digital sound recordable and playable device 10. The device includes a front cover 12 and a back cover 14. The front cover and back cover may have the same shape. The front cover and back cover may include a curvature so that when the front cover 12 and the back cover 14 are connected they form one generally continuous piece. The curvature of the front cover and/or back cover may be a constant curvature. The curvature radius may vary along the cover (e.g. it continuously varies from a maximum radius near or at the center of the cover to a minimum radius at or near the periphery of the cover. The curvature may gradually increase towards the edge of the covers. The covers may be flat near the edges where they join. The front cover may include holes 16 so that sound may travel through the front cover 12. The back cover may include holes. Preferably, the front cover may include a plurality of holes (e.g. about 13), and the number of holes may be increased or decreased depending on the size of the holes. A cover may include about 5 holes or more, about 8 holes or more, or about 12 holes or more. A cover may include about 50 holes or less, about 25 holes or less, or about 15 holes or less. The holes may be about 0.3 mm or larger, about 0.5 mm or larger, about 0.8 mm or larger, or even about 0.9 mm or larger in their largest dimension. The holes may be about 2.0 mm or smaller, about 1.5 mm or smaller, or about 1.2 mm or smaller (e.g. about 1.0 mm). The front cover and back cover when combined may include one or more apertures 18 to receive user inputs, create messages or recordings, receive messages or recordings, or a combination thereof. The componentry may extend through the one or more apertures and may include one or more of the following: buttons 20, attachment mechanisms 22, user controls 24, a microphone, a speaker, or a combination thereof.

When the front cover and back cover are combined they form a housing. The housing may be of any size so that components may be included in the housing and a message may be recorded and played. Preferably, the housing may be large enough so that a large speaker may be included in the housing such that the speaker plays a loud and clear message. The housing may have a diameter of about 1 cm or more, about 2 cm or more, or preferably about 3 cm or more. The housing may have a diameter of about 10 cm or less, about 8 cm or less, preferably about 6 cm or less (i.e. between about 3.5 cm and 4.5 cm). The housing includes a cavity for holding componentry. The componentry that may be found in the housing include: a speaker, a microphone, a power source, a printed circuit board, a laminated circuit board, a lock out switch, an attachment mechanism, connecting wires or leads, integrated circuits, a memory device, or a combination thereof.

The front cover 12, back cover 14, or both may include fasteners 26, as shown in FIG. 2. The fasteners may include any device capable of holding the front cover and back cover together. The fasteners may allow the front cover and the back cover to be taken apart so that the battery may be changed. The front cover and back cover may be permanently attached. The fasteners may be capable of holding the front cover and back cover together so that when the device is dropped from a distance of greater than about 0.5 m, about 1.0 m, about 1.5 m, or even greater than about 2.0 m the covers stay together. The housing may not be held together by screws, and the housing will be free of any exposed fasteners. Preferably, the housing is held together by one screw; however, more screws may be used (e.g., 2, 3, 4, or even 5 screws). The front cover, the back cover, or both may include a projection with a hole that aligns with a recess with a hole in the front cover, the back cover, or both so that a screw may pass through the hole in the projection and the hole in the recess and hold the front cover and the back cover together. The projection may include a snap feature so that the projection may snap into the recess without a screw such that the front cover and the back cover are fixedly attached to each other. The device may include one or more fasteners (e.g. three fasteners evenly spaced apart from each other at about 120 degrees). Preferably, the device may include at least two fasteners and one screw so that the two covers are held together. The two fasteners may be located in close proximity to each other on one side of the device (e.g. the top, the bottom, a side, or a combination thereof), and the screw may be located on an opposing side of the device. For example, two fasteners may be located about 90 degrees from each other and the screw may be located about 135 degrees from either fastener. The fasteners may be a cantilever style fastener having a snap fit. The fastener may have a male portion and a female portion. The fasteners may be an annular style fastener having a snap fit. The fasteners may be a screw or some other helically threaded device. The fasteners may be robust enough so that the front cover and back cover can be taken apart 40, 60, 100, or more times without the fasteners failing or breaking.

The device may include a cover. The cover may be any material that substantially surrounds the device so that the device is protected, the design of the device is changed, or both. The cover may be a skin, a transparent covering, a opaque covering, a semi-transparent covering, or a combination thereof. The cover may be customizable. The cover may cover only a portion of the device. The cover may substantially cover the entire device. The user controls and/or buttons may be covered by the cover, but may not inhibit use of the buttons and/or user controls. Preferably, the user controls and/or buttons may be exposed (i.e. they may stick through the cover). The cover may be thin. For example, the cover may be about 2 mm or less, about 1 mm or less, about 0.5 mm or less, or even about 0.2 mm or less in thickness. The cover may have a thickness of between about 0.001 mm and 2 mm or about 0.01 mm and about 1 mm. The cover may be made of any material that is customizable. The cover may be made of any material that may protect the device. The cover may be made of a polymer. The cover may be made of plastic, rubber, neoprene, a natural material, a synthetic material, or a combination thereof. The cover may be made of multiple pieces. The cover may be made of one unitary piece. The cover may be flexible. The cover may be stretchable so that the cover may stretch so that the device may be placed in the device and the cover retracts to fit the device. The cover may be plastically deformable. The cover may be customized by any method known for customizing. For example, a design may be screen printed, ink jet printed, sewn, painted, dyed, cut, digital printed, offset printed, gravure, laser printed, thermal printed, or a combination thereof. The cover may include one or more holes that mirror the device. For example, the cover may include holes for the speaker and microphone. The cover may perform any of the teachings herein discussed for the housing.

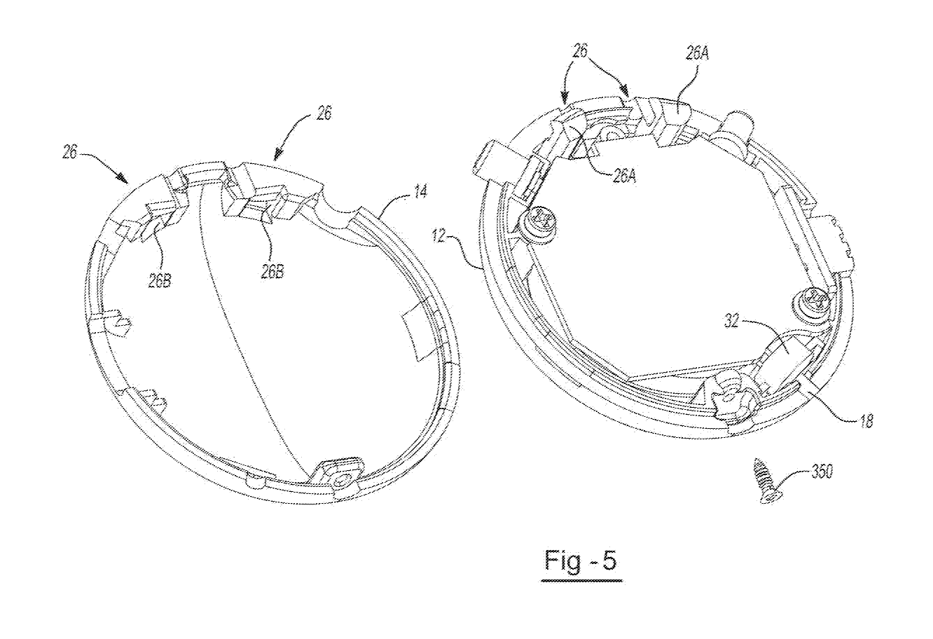

As illustrated in FIG. 5 the front cover 12 and the back cover 14 include fasteners 26. The fastener on the front cover 12 is a male fastener 26A and the fastener on the back cover is a female fastener 26B; however, the fasteners may be reversed. The front cover includes an aperture 18 for the microphone 32. The device 10 also includes a screw 350 so that when the front cover and the back cover are put together the screw 350 will fixedly attach to the front cover to the back cover and vice versa.

The housing preferably may include a power source 28. The power source may be selected from any power source capable of powering the device. Preferably, the power source will be a battery (e.g. CR2430).

The cover may include a speaker support 30, as illustrated in FIG. 3. The speaker support 30 may be of any design, size, or shape that will hold the speaker in place. The speaker may be attached directly to the front cover, the back cover, or both. The speaker may be attached to the front cover, the back cover, or both by any device and/or apparatus that will securely hold the speaker in place. The speaker may be free of direct attachment to the printed circuit board. The speaker may be indirectly attached to the printed circuit board via wires, leads, or both. The speaker may be free of any components, attachments, devices, or a combination thereof between the speaker face and a cover. The speaker may be held in place by only the speaker support. The speaker support 30 may include ridges so that the speaker 36 can be snap fit into the speaker support. The speaker support 30 may be configured so that the speaker can be fastened into place (e.g. glued). The speaker support may form a seal around the entire circumference of the speaker. Preferably, the speaker support may include gaps around the circumference of the speaker so that air may move around the circumference of the speaker. Preferably, the speaker 36 is mounted to the front cover, which includes holes 16.

As has previously been described the covers may include a curvature. The curvature may be subtle enough so the cover is capable of including a large speaker, but not so subtle that the speaker 36 comes into contact with the cover. Preferably, there will be an air gap between the cover and the speaker. The air gap may span the entire diameter of the speaker or may only span a portion of the speaker. The air gap thickness may be constant across the face of the speaker. Preferably, the thickness of the air gap will vary across the face of the speaker in accordance with the curvature of the cover. The curvature of the cover may form an acoustic geometry. The acoustics of the housing may be substantially distorted (e.g. sound quality and/or volume are greatly reduced) when one cover is removed from the device. The housing may include a UV stabilizer to prevent yellowing. The housing, user controls, buttons, or a combination there of may be made of a polymer e.g. a thermoplastic polymers such as acrylonitrile butadiene styrene (ABS), polyamide, polyethylene, poly vinyl chloride, polyethylene terephlthalamide, or other polyester. The housing may be molded (e.g. injection molded). The housing may include one or more portions that include a thermoplastic elastomer or other material imparting a “soft touch feel.” The polymer of the housing may be such that it can and does receive a graphic thereon (e.g. a printed graphic, an adhesive label, or decal etc. . . . ). The housing may include graphics. The graphics may be painted on the housing. The graphics may be stickers. The graphics may be applied in any manner capable of forming an image on the housing. The graphics may be applied to the front cover, the back cover, and/or both.

The housing may be attached to or include an attachment device 44, an attachment mechanism 22, or both. The attachment device and/or attachment mechanism may be removably attached to the front cover, the back cover, or both covers. Preferably, the attachment device and/or attachment mechanism is permanently attached to the front cover, the back cover, or both covers. The attachment device and/or attachment mechanism may be a unitary piece with the front cover, the back cover, or both. The attachment device and/or attachment mechanism may be a separate piece from the front cover, the back cover, of both so that the attachment device and/or attachment mechanism is formed and then fixedly attached and/or permanently attached to the front cover, the back cover, or both covers. The attachment device and/or attachment mechanism may be attached by glue, epoxy, melted plastic, a heat seal, or a combination thereof. The attachment device and/or attachment mechanism may be any device useful for connecting the device to a person or their property. The attachment device 44 may be a necklace, chain, ear rings, carabineer, clip, strap, or the like. The attachment device may be shaped. The attachment device may be any shape that allows the device to be attached to a user, a user's possessions (e.g. clothing, backpack, etc. . . . ), or both. The attachment devices may be shaped like animals, hearts, stars, planets, toys, action figures, cartoon characters, or a combination thereof. The attachment devices may be replacable. The attachment devices may be interchangeable. For example, the attachment device may be a necklace one day and the next day may be switched to a clip. In another example, one day the attachment device may be in the shape of a dog and the next day may be changed to a lion shape. The attachment device and/or attachment mechanism should be robust enough so that it is not easily broken and the device lost. Preferably, a portion of the attachment device and/or attachment mechanism may be included inside of the housing. For example, the attachment device may include a portion that penetrates a wall of the housing and interferingly engages the housing to resist pull through.

The speaker may be any speaker capable of producing a high quality audible message. The speaker may be capable of producing a decibel level of more than about 50 db, about 60 db, about 70 db, or even more than about 80 db. The speaker may produce a sound that is about 110 db or less, about 100 db or less, or about 90 db or less. Preferably, the speaker makes a sound between about 60 and 90 db. The speaker may be greater than about 15 mm or larger, about 20 mm or larger, or about 25 mm or larger in its largest dimension. The speaker may be about 50 mm or smaller, about 40 mm or smaller, or about 30 mm or smaller in its largest dimension (e.g. about 26 mm). The speaker may be relatively flat so that the overall height of the package can be kept small. The height of the speaker may be less than about 5 mm, about 4.5 mm, about 4.0 mm, or even less than about 3.5 mm (e.g. about 3.7 mm).

A microphone 32 may be contained in the housing as is illustrated in FIG. 3. The housing may include an aperture adjacent to the microphone so that message quality is not degraded. The front cover, back cover, or both may include a microphone support 34. The microphone support may hold the microphone in place. The microphone support 34 may aid in maintaing message quality. The microphone support may create a gap that isolates the microphone from the other components so that the microphone is free of interference from the other components. The microphone support may create an air gap so that sound can travel through the aperture to the microphone. The acoustics and acoustic geometry may be enhanced by an integral microphone support that isolates the microphone from the other componentry. The microphone may be substantially surrounded on one side by the microphone support and the housing on the other side. The microphone support may protect the microphone from damage. For example, the microphone will not move and hit the housing if the device is dropped, thrown, banged, or a combination thereof. The microphone support and housing may isolate the microphone form noise that is not directed through the aperture. The aperture may be the only place where sound may be directed towards the microphone. The aperture may funnel the sound to the microphone so that clear and audible recordings may be made.

The microphone aperture may be any size suitable to allow for a recording. The aperture may be small enough to protect the microphone from external contamination. The aperture may be about 0.5 mm or more, about 1.0 mm or more, or about 1.2 mm or more in its largest dimension. The aperture may be about 2.0 mm or less, about 1.8 mm or less, or about 1.5 mm or less in its largest dimension (e.g. about 1.3 mm).

The microphone 32 may be oriented parallel to the speaker 36, power source 28, and/or both. Preferably, the microphone 32 is oriented perpendicular to the speaker 36, power source, and/or both with the microphone receiver facing away from the speaker. More preferably, the microphone 32 may be positioned so that the microphone 32 faces an aperture 18 so that sound will be channeled to the microphone via the aperture 18 and the microphone support 34. The microphone may face a seam in the housing (i.e. where the front cover and back cover combine). The microphone may be any microphone device capable of making a clear and audible recording. The microphone may be about 2 mm or more, about 4 mm or more, or about 5 mm or more in its largest dimension. The microphone may be about 15 mm or less, about 12 mm or less, about 10 mm or less, or even about 7 mm or less (e.g. about 6 mm) in its largest dimension. The microphone may be free of direct attachment to the printed circuit board. The microphone may be indirectly attached to the printed circuit board via wires, leads, or both. The microphone may be positioned parallel to the printed circuit board. Preferably, the microphone may be positioned perpendicular to the printed circuit board.

The device may include an integrated circuit board. The circuit board may include memory capabilities. The memory may be capable of storing voice recordings. The memory may be capable of storing recordings that are about 10 seconds or longer, about 20 seconds or longer, about 25 seconds or longer. The memory storage device may store voice recordings that are about 10 minutes or less, about 5 minutes or less, about 2 minutes or less, about 1 minute or less, or about 40 seconds or less (e.g. about 30 seconds). For example, the memory may be capable of storing voice recordings for between about 30 seconds and about 2 minutes. The integrated circuit may provide a notice so that the user knows when the memory has been filled with a recording. The notice may be any method of informing the user that the memory is full. For example, the device may beep or a light may come on when the memory is full. The integrated circuit may be any integrated circuit capable for use in a device that stores and plays messages. For example, a Tritan Technology TRROXX Series or TRR030E may be used. Additional aspects of the invention can be gleaned from the teachings herein, including those of FIGS. 6 through 15 of Provisional Application Ser. No. 61/303,812, filed Feb. 12, 2010, incorporated by reference herein, which show alternative components that may be used herein.

The device may be capable of recording a plurality of messages. The device may include a feature that allows the user to select a single message, a plurality of messages, or a combination thereof to play and/or delete. The user may be able to jump from message to message without listening to a previous message. The user may be able to select any message from a queue without having to skip over messages.

The device may include an indicator. The indicator may indicate that a message is being recorded, deleted, played, stored, or a combination thereof. The indicator may indicate that the device is turned on. The indicator may let the user know when the recording feature has been activated. The indicator may be a light. The indicator light may blink when the device is recording. The indicator light may be constant when the device is recording. The indicator light may be any light suitable for indicating that the device is on or that a message is being recorded, deleted, played, stored, or a combination thereof. The indicator may be a light emitting diode, an incandescent light bulb, or any other device capable of producing light. The indicator may make a sound such as a beep to indicate that a recording is beginning or that the recording has ended. The indicator may beep when the device is turned on. The indicator may beep when the device is turned off.

The device may include a lock switch 38. The lock switch may include a protect setting, a record setting. or both. The lock switch 38 may aid in the prevention of accidental erasures. The lock switch may be flush with the housing. The lock switch may protrude outside the housing. Preferably, the lock switch will be contoured similarly to the contour of the housing. The shape of the lock switch may be such that it substantially conforms in shape of the cover. The lock switch may include ridges so that the user can easily move the lock switch. The lock switch may include an indicator so that the user can see if the lock switch is in the protect setting or the record setting. The lock switch may require a force of about 10 N or more, about 15 N or more, about 20 N or more, or even about 25 N or more to move the lock switch. The lock switch may require about 40 N or less, about 35 N or less, or about 30 N or less to move the lock switch.

The device may be assembled together with a packaging 40. The package may be of any shape and size suitable for holding the device. The package may include a plurality of compartments, e.g. adjoining compartments. The packaging may have at least two compartments. Preferably, the package will have three compartments. More preferably, the package may have four compartments. The package may include a compartment for holding the device 46. The package may include a storage area 42 capable of packaging an attachment device 44. A storage area 42 may also include advertisement, notices, product information, brochures, the like, or a combination thereof. The package may include one or more display areas 48 so that advertisement may be displayed or for hanging the package on a retail shelf. The package may be made of any material suitable for holding and displaying the device. The package may be a clamshell design so that two portions are put together and sealed around the edges. The package may be of a design so that movement of the items is prevented. The package may be made of any material that protects and holds the device. Preferably, the package may be transparent plastic material that includes holes exposing the user controls so that the user controls can be depressed and the pre-recorded message is played. The sides of the package may be generally parallel. The sides of the packaging may be curved. The sides of the packaging may be arcuate. The sides of the packaging may project in, out, or both. The storage areas, display areas, compartment for holding the device, or a combination thereof may be any shape so that the device may be packaged. Preferably, the storage areas, display areas, compartment for holding the device, or a combination thereof may be generally oval or circular. The storage areas, display areas, compartment for holding the device, or a combination thereof may be shaped like talk bubbles, thought bubbles, or both. Preferably, the sides of the package will gradually project away from each other. The package may have one or more transparent portions. The package may be made of a thermoformed plastic.

Other features may be employed according to the teachings of U.S. Patent Application Publication 2009/0074224, incorporated by reference, such as one or more of the wristband, digital electronic module, bulbous housing, water resistance, attachment mechanisms, methods of use, or other features addressed therein.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus. an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A portable and wearable sound recordable and playable device comprising:
a front cover and a back cover, that form a housing, which includes a cavity for holding componentry;
the componentry including at least a microphone and a speaker,
wherein the front cover and back cover are substantially similar in shape and include a curvature so that a cavity of air is formed between the speaker and the front wall cover;
wherein the front cover and the back cover when attached form an acoustic geometry.

2. The device of claim 1, wherein the microphone is oriented perpendicular to a battery.

3. The device of claim 1, wherein the microphone faces a side of the front cover, back cover, or both.

4. The device of claim 1, wherein the speaker is mounted on a housing that is attached to the front cover.

5. The device of claim 4, wherein the speaker is snap fit and/or glued onto the housing.

6. The device of claim 1, wherein the device includes a lock switch to prevent accidental erasure of messages.

7. The device of claim 6, wherein the lock switch is shaped in a manner so that it substantially conforms to the shape of the cover.

8. The device of claim 1, wherein the front cover, the back cover, or both include one or more fittings so that the front cover and the back cover can be snap fit together.

9. The device of claim 8, wherein the fittings are cantilever fittings.

10. The device of claim 1, wherein the housing is free of exposed screws.

11. The device of claim 1, wherein the device is capable of storing recordings that are 25 seconds or longer.

12. The device of claim 6, wherein the lock switch requires a force of about 10 N or more to be moved.

13. The device of claim 5, wherein the speaker is free of direct attachment to the printed circuit board.

14. The device of claim 5, wherein the speaker is indirectly attached to the printed circuit board via wires, leads, or both.

15. The device of claim 5, wherein the speaker support includes gaps around the circumference of the speaker so that air may move around the circumference of the speaker.

16. The device of claim 1, wherein sound is channeled to the microphone via an aperture and a microphone support.

17. The device of claim 1, wherein the acoustic geometry is enhanced by an integral microphone support that isolates the microphone from the other componentry.
